(19) United States
(12) Patent Application Publication
(10) Pub. No.: US 2008/0117443 A1
(43) Pub. Date: May 22, 2008

(54) Method to Utilize Non-Image Areas in Image Reproduction

(76) Inventor: Terry R. Ham, Royal Palm Beach, FL (US)

Correspondence Address: Terry Ham, 1567 Fiddlewood Court, Royal Palm Beach, FL, 33411, US

(21) Appl. No.: 11/560,747

(22) Filed: Nov. 16, 2006

(51) Int. Cl. B41B 1/02

(52) U.S. Cl. 358/1.9

(57) ABSTRACT

The method embodies a new approach to the characteristics of the elementary dots or pixels used in the process of image reproduction. Non-image areas within each pixel or elementary dot are utilized to enhance the reproduction quality of an image. Higher resolution, better clarity, and more vibrate color intensity can be attained by using the method.

The non-images areas within the pixels or dots may be used in a variety of different manners, including but not limited to the following. The dots can be rotated on an axis by degrees in sequence, for different color channels, over time for images in motion, or a combination of these schemes. The technique for utilization of these non-image areas would be determined for each specific application or process.

### CROSS-REFERENCE TO RELATED APPLICATIONS

Not Applicable

### FEDERALLY SPONSORED RESEACH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The most obvious mode of the method encompasses a new approach to the phenomenon of dot gain in the process of image reproduction for printing applications. As ink is applied to a substrate the dots used in printing grow larger in a process referred to as dot gain. Non-image areas within each pixel or elementary dot are utilized to harness the natural dot gain inherent to the process.

The phenomenon of dot gain is intrinsic to the process of image reproduction. In preparation for reproduction, images are screened or separated into pixels or elementary dots. Thereafter, during each step, or at lest some steps, of the process, these dots then grow in size or undergo dot gain. This phenomenon has consistently been considered a problem to be controlled or compensated for.

### BRIEF SUMMARY OF THE INVENTION

During the process of image reproduction, non-image areas can be created within each pixel or elementary dot. These non-image areas within each dot are then utilized to harness the natural dot gain inherent to the process. The natural dot gain that occurs during printing will fill in the non-image areas of the dot. This will significantly reduce the printing dot's growth in size. Thus, the negative effects of dot gain in reproducing an image can be eliminated.

### BRIEF DESCRIPTION OF THE SEVERAL VIEWS OF THE DRAWING

Not Applicable

### DETAILED DESCRIPTION OF THE INVENTION

The pixels or elementary dots used in the reproduction process are used in many deferent frequencies, shapes and sizes. To date, however, all of these pixels or elementary dots have a single common characteristic; they are each one solid and continuous form. The method that I propose would have non-image areas within the dot. The non-image areas within the dot become a device for better control of dot gain. The natural dot gain that occurs during the reproduction process will fill in the non-image areas of the dot. This will significantly reduce the elementary dot's growth in size.

The method can be applied to any process of image reproduction that uses pixels or elementary dots. The method can also be applied whether the image is static or in motion.

Although the method is in no way limited to static images, for the purpose of concept development the process of newspaper printing will be used as an example of an application of the method. The process of newspaper printing was chosen because of the significant amount of dot gain inherent in the process. Currently, in the United States, the industry standard assumes dot gain of 30%.

In theory, an image that requires a 50% screen should cover 50% of the printed area. However, with a process in which 30% dot gain is realized, 65% of the printed area is actually covered with ink. The quality of image reproduction in printing newspapers suffers because of the “muddied” or “plugged” screens caused by the 30% dot gain.

Newspapers today use a number of methods in an effort to control dot gain. Various dot shapes, tone curves, and press profiles are used in an attempt to solve this problem. To some degree these methods help to minimize dot gain, however the screens still become “plugged.” Current methods of compensating for dot gain cannot eliminate the negative effects of dot gain without causing other image quality problems.

Images to be reproduced on newsprint are sent from computer workstation through a Raster Image Processor (RIP) where the image is prepared for printing. The RIP settings determine a number of the individual parameters used for printing on newsprint including: line screens, screen angles, dot shape, and other characteristics of the image. The image is output through an imager to film, which is used to develop a printing plate, or directly to the printing plate.

The method applies a completely new dot at the RIP or imaging computer in computer to plate (CTP) applications. The size of the dot cannot be adjusted for dot gain on the press without losing detail, shadows and highlights. Instead, the method will adjust the surface area of the dot without significant change in dot size. Within each dot, non-image areas are applied using a mathematical formula. The exact shape and size of the non-image areas would be determined for each individual application, however, it is recommended that the non-image areas be dispersed evenly within the dot using geometric shapes. To return a dot to the original size after 30% dot gain; it must first have the image area inside the dot reduced by 23%.

The method to utilize non-image areas in image reproduction is the first and only method that employees non-image areas within the pixel or elementary dot. It represents a fundamental change in approach to the phenomenon of dot gain. Linear to paper reproduction can be achieved using the method. It also becomes possible to build graduation curves directly into the dot definition. The quality of image reproduction will be greatly enhanced with more clarity and higher resolution.

1. During the process of reproducing an image, non-image areas can be created within the elementary dot or pixel.

2. These non-image areas within each pixel or elementary dot can be utilized to enhance the reproduction quality of an image.
